(19) United States
(12) Patent Application Publication
(10) Pub. No.: US 2026/0225211 A1
(43) Pub. Date: Aug. 6, 2026

(54) MULTIFUNCTIONAL ADAPTER DEVICE

(71) Applicant: GUOCHANG COLD FORGING CO., LTD., Taichung City (TW)

(72) Inventor: Ting-Wei CHU, Taichung City (TW)

(21) Appl. No.: 19/044,728

(22) Filed: Feb. 4, 2025

(51) Int. Cl. B25B 23/00

(52) U.S. Cl. CPC B25B 23/0035; B25B 23/0021

(57) ABSTRACT

A multifunctional adapter device includes an inner rod, a first sleeve, and a second sleeve. The first sleeve and the second sleeve are slidably sleeved on two opposite ends of the inner rod. A first side rod portion of the inner rod can be inserted into a first object when protruding from the first sleeve. When the first side rod portion retracts into the first sleeve, a second object can be inserted into the first sleeve. A second side rod portion of the inner rod can be inserted into a third object when protruding from the second sleeve. When the second side rod portion retracts into the second sleeve, a fourth object can be inserted into the second sleeve. Therefore, the multifunctional adapter device can not only be used as an extension rod, but also be used for the adaptation between different objects.

### BACKGROUND

### Field of the Invention

The present invention relates to an adapter device, and more particularly to a multifunctional adapter device.

### Description of Related Art

When workers attempt to use hand tools, pneumatic tools, or electric tools to install or remove a fastener (such as but not limited to nuts, bolts, screws, etc.) located in the deep of an object, an adapter device with an extension function is required. As shown in FIG. 1, a first end 71 of the adapter device 7 is the driving end for connecting to a hand tool, a pneumatic tool, or an electric tool, and a second end 72 of the adapter device 7 is the driven end for inserting into the screw head of the screw.

However, different driven objects of different sizes or types require different adapter devices. Moreover, frequently replacing adapter devices will reduce work efficiency, and carrying different adapter devices will also be a burden on the workers.

### SUMMARY

To this end, the objective of the present invention is to provide a multifunctional adapter device, which can overcome the problem that the prior art cannot adapt to objects of different sizes or types, and which is helpful to improving the work efficiency of users and reducing the burden of users carrying tools.

A multifunctional adapter device provided in accordance with one embodiment of the present invention is suitable for connecting different objects, and includes: an inner rod, including a main rod portion, a first side rod portion connected to a first end of the main rod portion, and a second side rod portion connected to a second end of the main rod portion opposite to the first end of the main rod portion; a first sleeve, slidably sleeved on the inner rod, and including a first inner position and a first outer position relative to the inner rod; and a second sleeve, slidably sleeved on the inner rod, and including a second inner position and a second outer position relative to the inner rod; wherein, when the first sleeve is in the first inner position, the first side rod portion of the inner rod protrudes from the first sleeve in an extension direction of the multifunctional adapter device, so as to allow the first side rod portion to be inserted into a first object; when the first sleeve is in the first outer position, the first side rod portion of the inner rod retracts into the first sleeve, so as to allow a second object to be inserted into the first sleeve; when the second sleeve is in the second inner position, the second side rod portion of the inner rod protrudes from the second sleeve in the extension direction of the multifunctional adapter device, so as to allow the second side rod portion to be inserted into a third object; and when the second sleeve is in the second outer position, the second side rod portion of the inner rod retracts into the second sleeve, so as to allow a fourth object to be inserted into the second sleeve.

In this way, compared with the prior art, the multifunctional adapter device of the present invention can adapt more different objects. Moreover, the objects applicable to a single end of the multifunctional adapter device can be either driving objects or driven objects.

Optionally, a shape of a projection of the first side rod portion in the extension direction of the multifunctional adapter device is different from that of the second side rod portion in the extension direction of the multifunctional adapter device.

Optionally, an inner diameter of the second sleeve is different from that of the first sleeve. In this way, two opposite ends of the multifunctional adapter device can be adapted to different objects, respectively.

Optionally, the first sleeve includes a first outer sleeving portion and a first inner sleeving portion connected to the first outer sleeving portion, and the first outer sleeving portion is for the second object to be inserted thereinto; the second sleeve includes a second outer sleeving portion and a second inner sleeving portion connected to the second outer sleeving portion, and the second outer sleeving portion is for the fourth object to be inserted thereinto; and an inner diameter of the first outer sleeving portion is different from that of the second outer sleeving portion.

Optionally, the first sleeve includes a first outer sleeving portion and a first inner sleeving portion connected to the first outer sleeving portion, and the first outer sleeving portion is for the second object to be inserted thereinto; the second sleeve includes a second outer sleeving portion and a second inner sleeving portion connected to the second outer sleeving portion, and the second outer sleeving portion is for the fourth object to be inserted thereinto; an outer diameter of the first outer sleeving portion of the first sleeve and a contour shape of a projection of the first outer sleeving portion in the extension direction of the multifunctional adapter device is different from that of the first inner sleeving portion, and when the first sleeve is in the first outer position, the first outer sleeving portion is capable of being inserted into a fifth object; and an outer diameter of the second outer sleeving portion of the second sleeve, a contour shape of a projection of the second outer sleeving portion in the extension direction of the multifunctional adapter device, or both are different from that of the second inner sleeving portion, and when the second sleeve is in the second outer position, the second outer sleeving portion is capable of being inserted into a sixth object.

Optionally, the first sleeve includes a first outer sleeving portion and a first inner sleeving portion connected to the first outer sleeving portion, and the first outer sleeving portion is for the second object to be inserted thereinto; the second sleeve includes a second outer sleeving portion and a second inner sleeving portion connected to the second outer sleeving portion, and the second outer sleeving portion is for the fourth object to be inserted thereinto; an outer diameter of the first outer sleeving portion of the first sleeve, a contour shape of a projection of the first outer sleeving portion in the extension direction of the multifunctional adapter device, or both are different from that of the second outer sleeving portion of the second sleeve, the first outer sleeving portion is configured to be inserted into a fifth object, and the second outer sleeving portion is configured to be inserted into a sixth object.

Optionally, the first sleeve includes a first outer sleeving portion and a first inner sleeving portion connected to the first outer sleeving portion, and the first outer sleeving portion is for the second object to be inserted thereinto; and the first sleeve further includes a sleeve extension connected to an end of the first outer sleeving portion away from the first inner sleeving portion, an outer ring surface of the sleeve extension is provided with an annular protrusion, and a contour shape of a projection of the annular protrusion in the extension direction of the multifunctional adapter device is different from that of the first outer sleeving portion.

Optionally, the multifunctional adapter device further comprises a snap ring, which is sleeved on the sleeve extension of the first sleeve and clamped between the first outer sleeving portion and the annular protrusion of the sleeve extension.

Optionally, the first sleeve includes a first outer sleeving portion and a first inner sleeving portion connected to the first outer sleeving portion, and the first outer sleeving portion is for the second object to be inserted thereinto; the second sleeve includes a second outer sleeving portion and a second inner sleeving portion connected to the second outer sleeving portion, and the second outer sleeving portion is for the fourth object to be inserted thereinto; and the first outer sleeving portion is sleeved on the first side rod portion of the inner rod, the first inner sleeving portion is sleeved on the first end of the main rod portion of the inner rod, and both the second outer sleeving portion and the second inner sleeving portion are sleeved on the second side rod portion of the inner rod.

Optionally, a engaging groove is provided on one end of the first side rod portion away from the main rod portion, and the engaging groove is for the first object to enter thereinto.

Optionally, a receiving groove is provided on one end of the second side rod portion away from the main rod portion, the multifunctional adapter device further comprises an engaging member and a spring, the engaging member and the spring are arranged in the receiving groove, two opposite ends of the spring respectively abut against the engaging member and a bottom surface of the receiving groove, and the engaging member is used to engage with the third object.

Optionally, an outer ring surface of the main rod portion is provided with two first limiting grooves which are separated from each other in the extension direction of the multifunctional adapter device, and an inner surface of the first sleeve is provided with a first annular groove; an outer ring surface of the second side rod portion is provided with a second limiting groove, and an inner surface of the second sleeve is provided with a second annular groove; the multifunctional adapter device further comprises a first snap ring movably arranged in the first annular groove and a second snap ring movably arranged in the second annular groove; when the first sleeve is in the first inner position, the first snap ring enters one of the first limiting grooves; when the first sleeve is in the first outer position, the first snap ring enters the other one of the first limiting grooves; when the second sleeve is in the second inner position, the second snap ring abuts against the outer ring surface of the second side rod portion; and when the second sleeve is in the second outer position, the second snap ring enters the second limiting groove.

Optionally, at least one of outer end surfaces of the first side rod portion and the second side rod portion is provided with a magnetic member.

Optionally, the second sleeve is provided with a magnetic member.

### BRIEF DESCRIPTION OF THE DRAWINGS

Other aspects and advantages of the present invention will be found after studying the detailed description in conjunction with the following accompanying drawings:

FIG. 1 is an illustrative view of a conventional adapter device;

FIG. 2 is an exploded view of a multifunctional adapter device according to an embodiment of the present invention;

FIG. 3 is an illustrative view of a multifunctional adapter device according to an embodiment of the present invention when the first sleeve is in the first inner position and the second sleeve is in the second inner position;

FIG. 4 is a left side view of the multifunctional adapter device in FIG. 3;

FIG. 5 is a right side view of the multifunctional adapter device in FIG. 3;

FIGS. 6A and 6B are cross-sectional views of the multifunctional adapter device in FIG. 3;

FIG. 7 is an illustrative view of the usage state of a multifunctional adapter device according to an embodiment of the present invention when the first sleeve is in the first outer position and the second sleeve is in the second inner position;

FIG. 8 is an illustrative view of the usage state of a multifunctional adapter device according to an embodiment of the present invention when the first sleeve is in the first inner position and the second sleeve is in the second outer position;

FIG. 9 is an illustrative view of the usage state of a multifunctional adapter device according to an embodiment of the present invention when the first sleeve is in the first outer position and the second sleeve is in the second outer position;

FIG. 10A is an illustrative view of the usage state of a multifunctional adapter device according to an embodiment of the present invention when the first sleeve is in the first inner position and is inserted into a first object;

FIG. 10B is an illustrative view of the usage state of a multifunctional adapter device according to an embodiment of the present invention when the first sleeve is in the first outer position and a second object is inserted into the first sleeve;

FIG. 10C is an illustrative view of the multifunctional adapter device according to an embodiment of the present invention when the first sleeve is in the first outer position and a second object is inserted into the first sleeve;

FIG. 10D is an illustrative view of the usage state of a multifunctional adapter device according to an embodiment of the present invention when the first sleeve is in the first outer position and inserts into a fifth object;

FIG. 11A is an illustrative view of the usage state of a multifunctional adapter device according to an embodiment of the present invention when the second sleeve is in the second inner position and inserts into a third object;

FIG. 11B is an illustrative view of the usage state of a multifunctional adapter device according to an embodiment of the present invention when the second sleeve is in the second outer position and a fourth object is inserted into the second sleeve; and

FIG. 11C is an illustrative view of the usage state of a multifunctional adapter device according to an embodiment of the present invention when the second sleeve is in the second outer position and inserts into a sixth object.

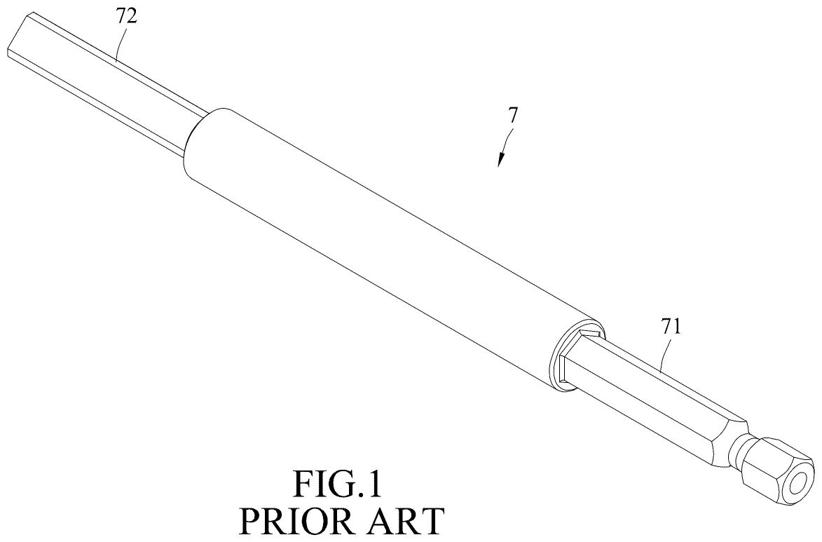

### DETAILED DESCRIPTION

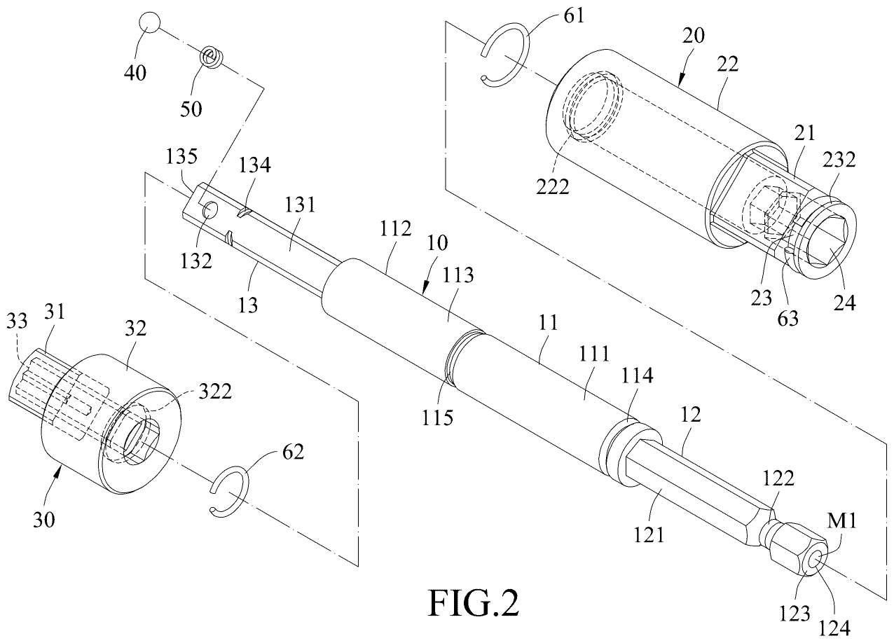

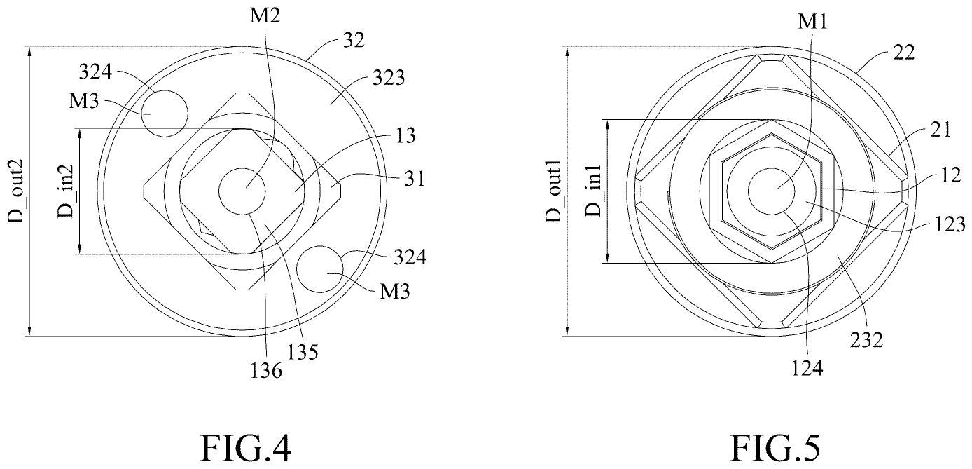

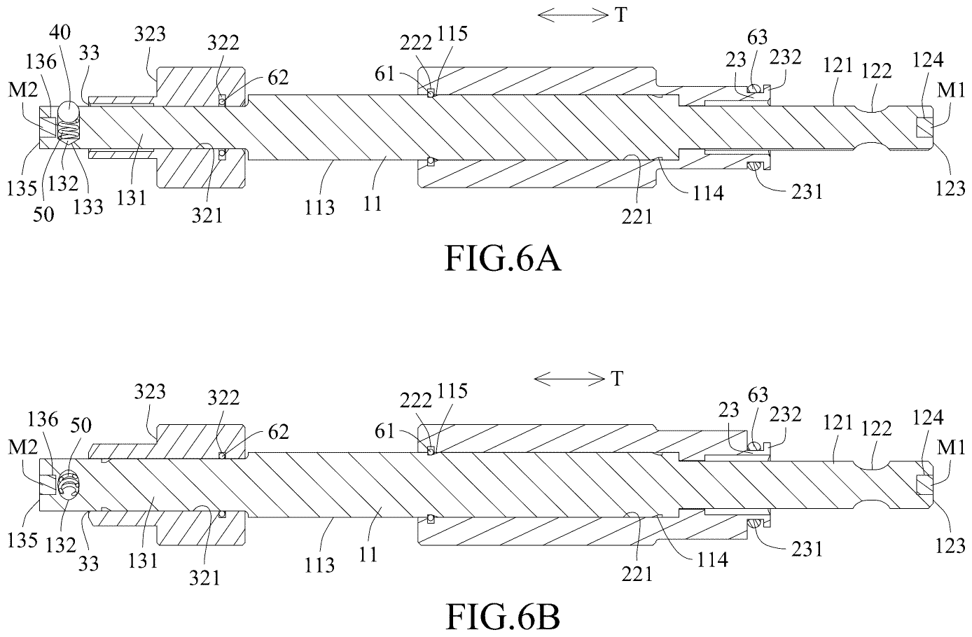

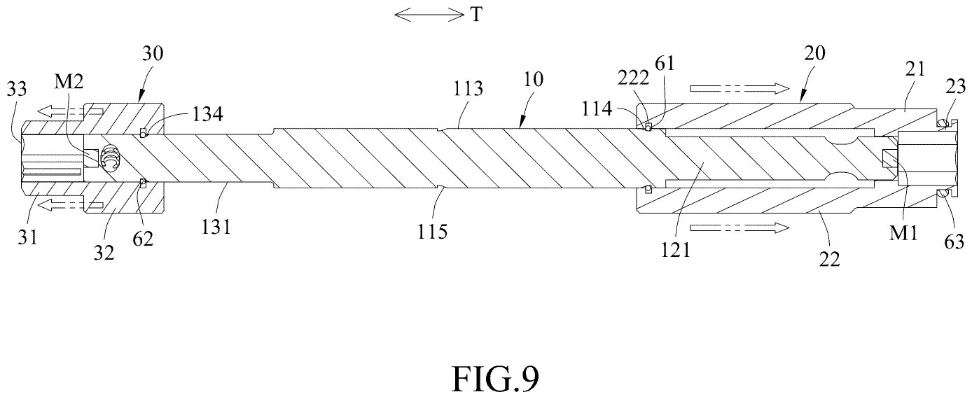

Please refer to FIGS. 2 to 11C, a multifunctional adapter device 1 provided according to an embodiment of the present invention is suitable for connecting different objects. The objects applicable to a single end of the multifunctional adapter device 1 can be either driving objects or driven objects. The driving objects include, but are not limited to, hand tools, pneumatic tools, or electric tools. The driven objects include, but are not limited to, fasteners (such as but not limited to nuts, bolts, screws, etc.), tool joints (such as but not limited to socket tools or screwdriver bits), etc. The objects applicable to the two opposite ends of the multifunctional adapter device 1 are objects that differ, for example but not limited to, in type, the inner diameter of the connection hole, the shape of the connection hole, the outer diameter of the connection head, or the outer contour shape of the connection head.

The multifunctional adapter device 1 includes an inner rod 10, a first sleeve 20, and a second sleeve 30.

The inner rod 10 includes a main rod portion 11, a first side rod portion 12 connected to a first end 111 of the main rod portion 11, and a second side rod portion 13 connected to a second end 112 of the main rod portion 11 opposite to the first end 111.

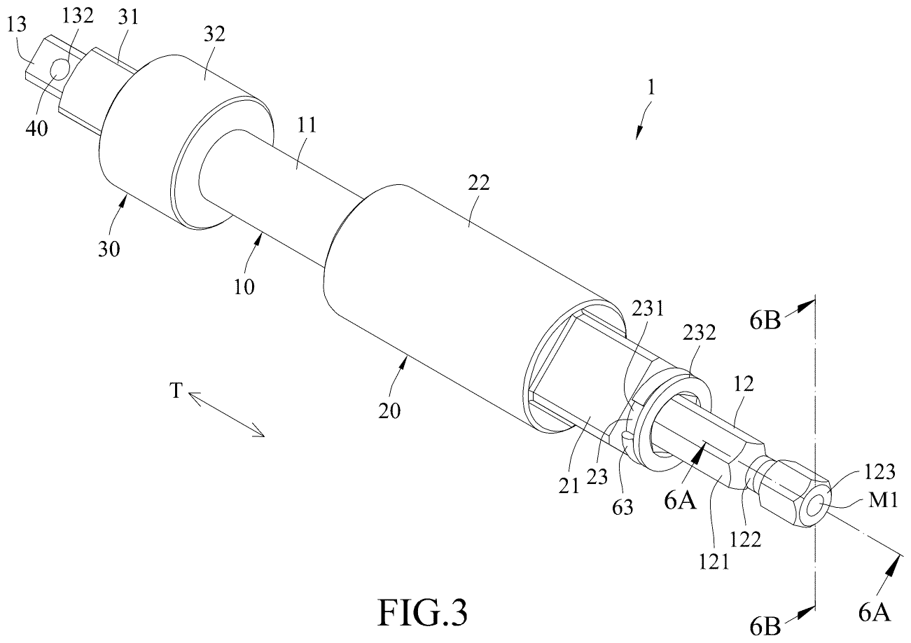

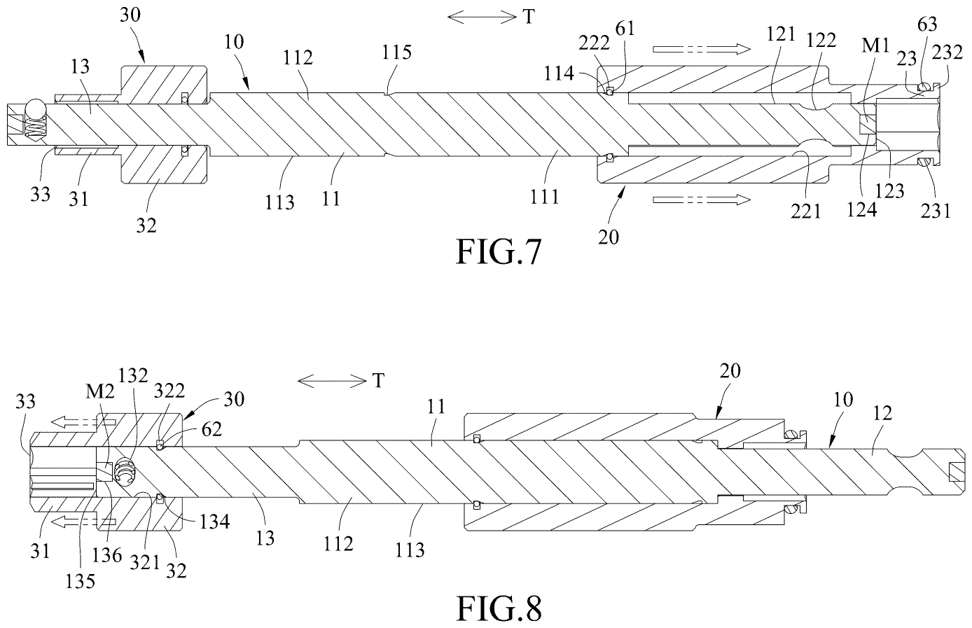

The first sleeve 20 is slidably sleeved on the inner rod 10. Thus, relative to the inner rod 10, the first sleeve 20 has a first inner position (as shown in FIGS. 3, 6A-6B, 8, 10A, and 11A-11C) and a first outer position (as shown in FIGS. 7, 9, and 10B-10D).

The second sleeve 30 is slidably sleeved on the inner rod 10. Thus, relative to the inner rod 10, the second sleeve 30 has a second inner position (as shown in FIGS. 3, 6A-7, and 10C-11A) and a second outer position (as shown in FIGS. 8-9, 10B, and 11B-11C).

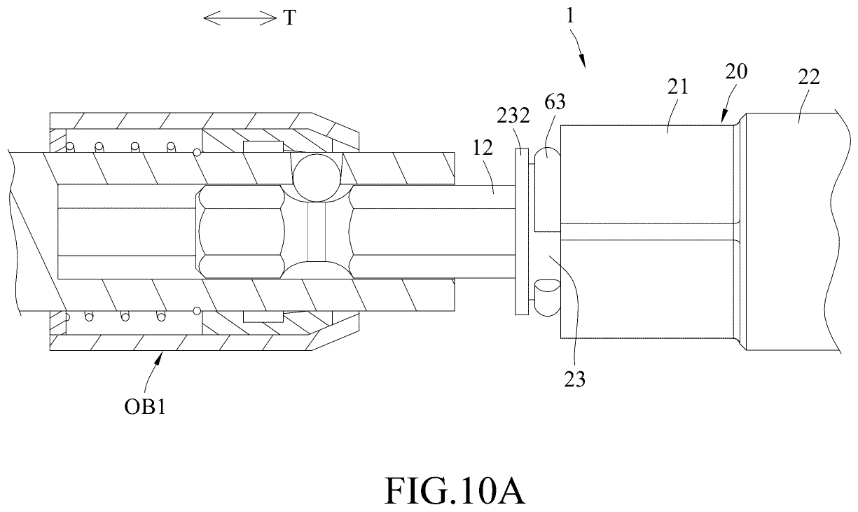

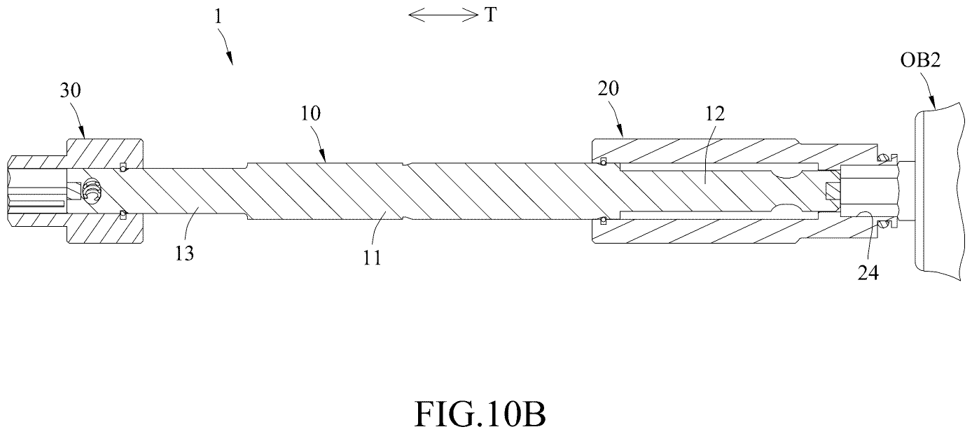

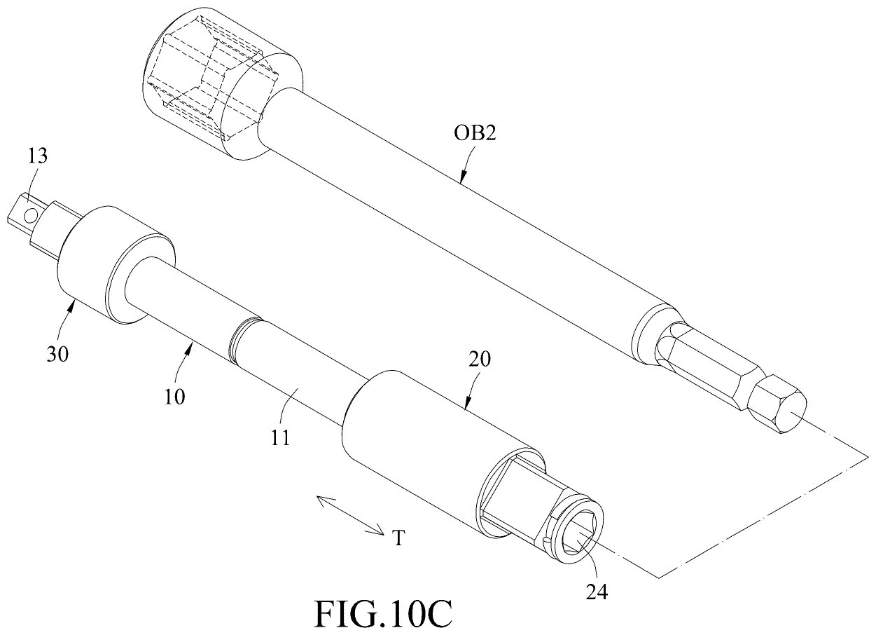

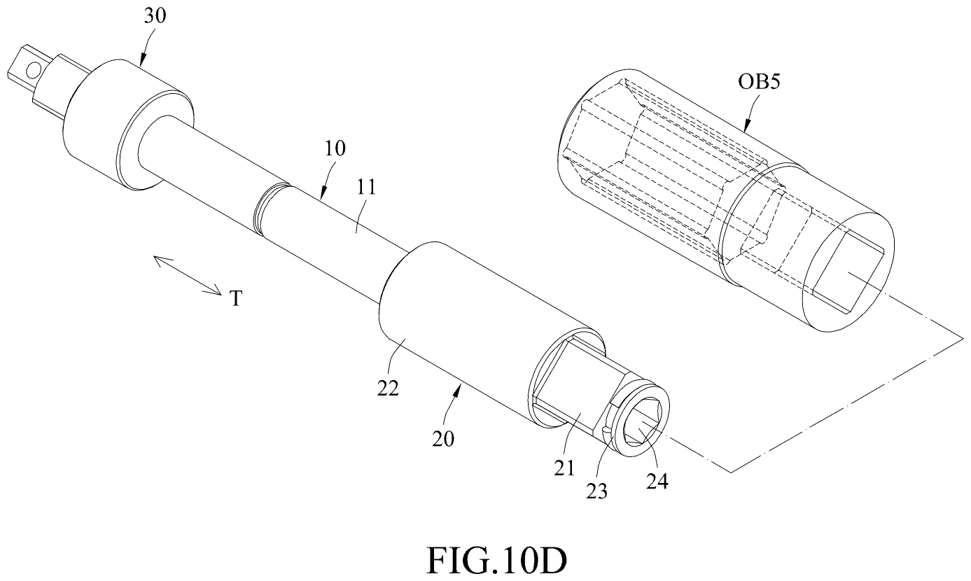

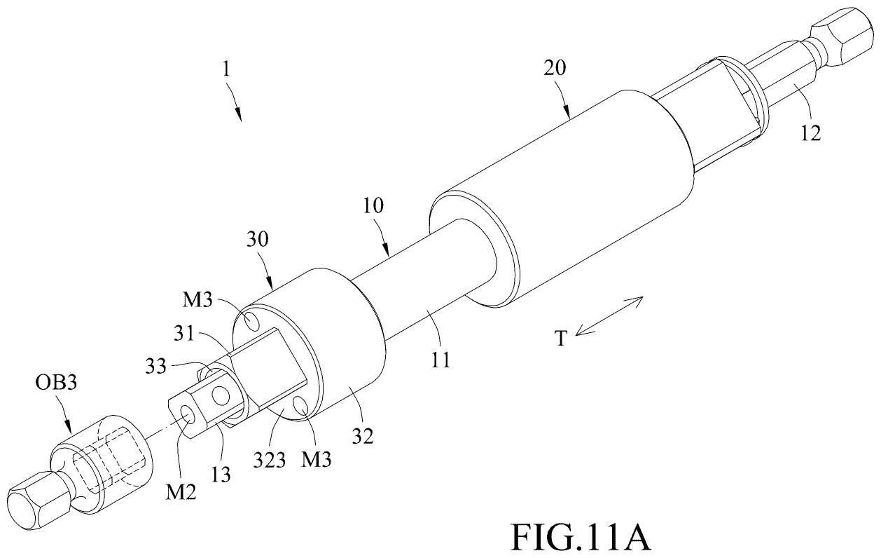

When the first sleeve 20 is in the first inner position, the first side rod portion 12 of the inner rod 10 protrudes from the first sleeve 20 in an extension direction T of the multifunctional adapter device 1, allowing the first side rod portion 12 to be inserted into a first object OB1, as shown in FIG. 10A. The first object OB1 includes, but is not limited to, an adapter head with one end that can be inserted by the inner rod 10 and the other end that can be inserted by a tool head (such as but not limited to a screwdriver head), or a socket tool with one end that can be inserted by the inner rod 10 and the other end that can be sleeved on other objects, or a screw head.

When the first sleeve 20 is in the first outer position, the first side rod portion 12 of the inner rod 10 retracts into the first sleeve 20 in the extension direction T of the multifunctional adapter device 1, allowing a second object OB2 to be inserted into the first sleeve 20, as shown in FIGS. 10B and 10C. The second object OB2 includes, but is not limited to, a driving object (such as but not limited to a hand tool, a pneumatic tool, or an electric tool) that can drive the multifunctional adapter device 1 to rotate, or a socket tool with one end that can be inserted into the outer connection hole 24 of the first sleeve 20 and the other end that can be inserted into other objects, or a tool head (such as but not limited to a tool head for inserting a screw head). The first side rod portion 12 retracted into the first sleeve 20 can act as a stop for the second object OB2 going deep into the first sleeve 20.

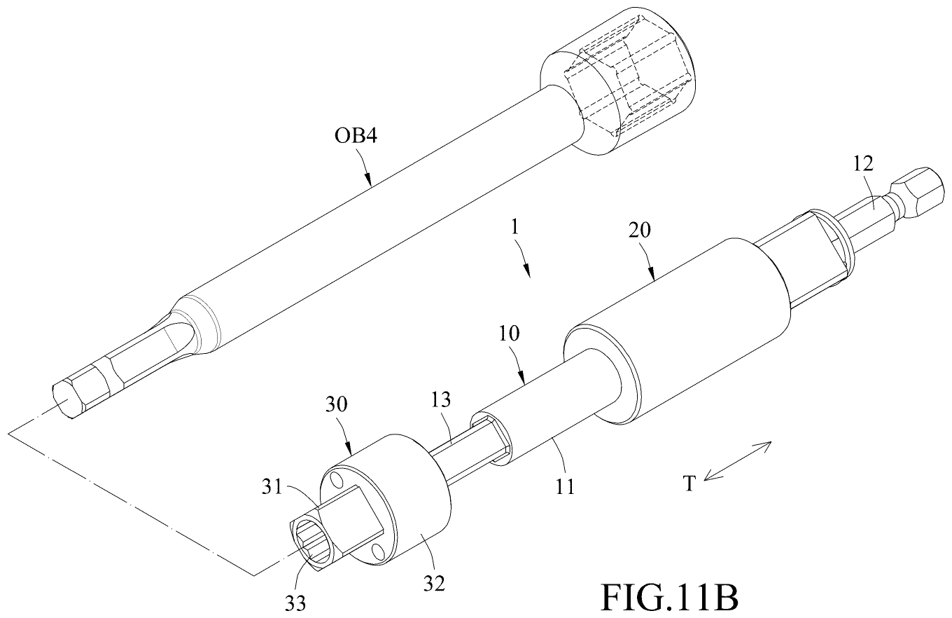

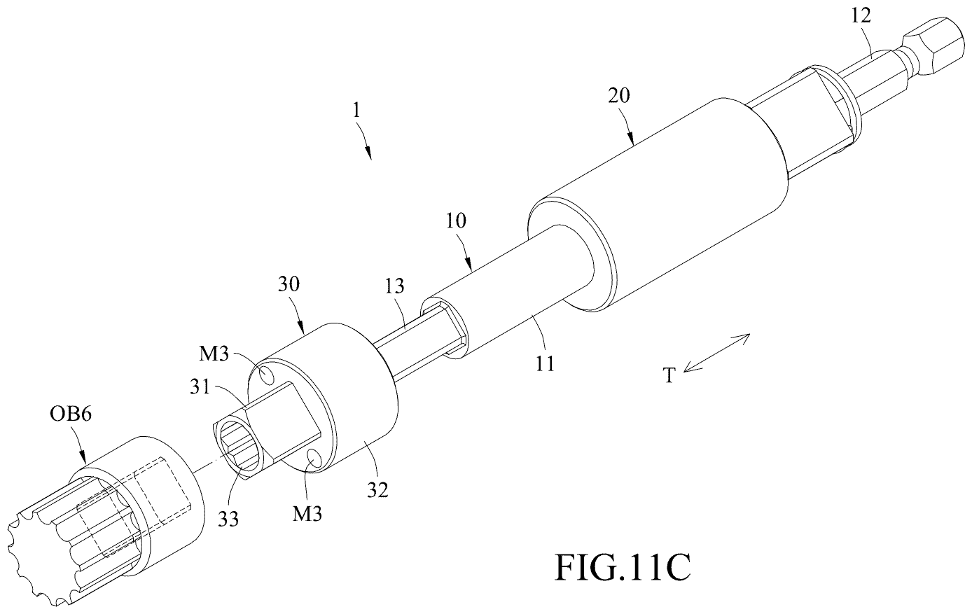

When the second sleeve 30 is in the second inner position, the second side rod portion 13 of the inner rod 10 protrudes from the second sleeve 30 in the extension direction T of the multifunctional adapter device 1, allowing the second side rod portion 13 to be inserted into a third object OB3, as shown in FIG. 11A. The third object OB3 includes, but is not limited to, a tool head (such as but not limited to a tool head for inserting a screw head).

When the second sleeve 30 is in the second outer position, the second side rod portion 13 of the inner rod 10 retracts into the second sleeve 30, allowing a fourth object OB4 to be inserted into the second sleeve 30, as shown in FIG. 11B. The fourth object includes, but is not limited to, a socket tool with one end that can be inserted into an outer connection hole 33 of the second sleeve 30 and the other end that can be inserted into other objects, or a tool head (such as but not limited to a tool head for inserting a screw head). The first to fourth objects are different from each other.

In this way, the multifunctional adapter device 1 of the present invention can adapt to more different objects, increase the work efficiency of workers, and also reduce the burden of workers carrying tools.

In this embodiment or other embodiments, the shape of a projection (such as but not limited to a hexagonal shape) of the first side rod portion 12 in the extension direction T of the multifunctional adapter device 1 can be optionally different from the shape of a projection (such as but not limited to a square shape) of the second side rod portion 13 in the extension direction T of the multifunctional adapter device 1, so that the two opposite ends of the multifunctional adapter device 1 can adapt to different objects respectively.

In this embodiment or other embodiments, the inner diameter of the first sleeve 20 can be optionally different from that of the second sleeve 30, so that the two opposite ends of the multifunctional adapter device 1 can adapt to different objects respectively.

In this embodiment or other embodiments, the first sleeve 20 includes a first outer sleeving portion 21 and a first inner sleeving portion 22 connected to the first outer sleeving portion 21. The first outer sleeving portion 21 is for inserting the second object OB2. The second sleeve 30 includes a second outer sleeving portion 31 and a second inner sleeving portion 32 connected to the second outer sleeving portion 31. The second outer sleeving portion 31 is for inserting the fourth object OB4. The inner diameter D_in1 of the first outer sleeving portion 21 can be optionally different from the inner diameter D_in2 of the second outer sleeving portion 31; specifically, the inner diameter D_in1 of the first outer sleeving portion 21 is greater than the inner diameter D_in2 of the second outer sleeving portion 31. In this way, the two opposite ends of the multifunctional adapter device 1 can be adapted to different objects respectively.

In this embodiment or other embodiments, at least one of the outer diameter D_out1 of the first outer sleeving portion 21 of the first sleeve 20 and the contour shape of a projection of the first outer sleeving portion 21 in the extension direction T of the multifunctional adapter device 1 can be optionally different from the first inner sleeving portion 22. At least one of the outer diameter D_out2 of the second outer sleeving portion 31 of the second sleeve 30 and the contour shape of a projection of the second outer sleeving portion 31 in the extension direction T of the multifunctional adapter device 1 can also be optionally different from the second inner sleeving portion 32. Therefore, when the first sleeve 20 is in the first outer position, a fifth object OB5 (such as but not limited to a socket adapter head) can be inserted into the outer connection hole 24 of the first sleeve 20 (that is, inserted into the first outer sleeving portion 21 and the sleeve extension 23), as shown in FIG. 10D; and when the second sleeve 30 is in the second outer position, the second outer sleeving portion 31 can be inserted into a sixth object OB6 [such as but not limited to a tool head (such as but not limited to a tool head for inserting a screw head)]. The first object OB1 to the sixth object OB6 are different from each other. In this way, the two opposite ends of the multifunctional adapter device 1 can adapt to more different objects respectively.

In this embodiment or other embodiments, at least one of the outer diameter D_out1 of the first outer sleeving portion 21 of the first sleeve 20 and the contour shape of a projection of the first outer sleeving portion 21 in the extension direction T of the multifunctional adapter device 1 can be optionally different from the second outer sleeving portion 31 of the second sleeve 30. Therefore, the first outer sleeving portion 21 is for inserting a fifth object OB5, and the second outer sleeving portion 31 is for inserting a sixth object OB6, so that the two opposite ends of the multifunctional adapter device 1 can adapt to more different objects respectively.

In this embodiment or other embodiments, the first sleeve 20 can optionally further include a sleeve extension 23 which is connected to the end of the first outer sleeving portion 21 away from the first inner sleeving portion 22. An outer ring surface 231 of the sleeve extension 23 can be optionally provided with an annular protrusion 232. The contour shape of a projection of the annular protrusion 232 in the extension direction T of the multifunctional adapter device 1 can be optionally different from the first outer sleeving portion 21, so that the first end of the multifunctional adapter device 1 can be stably inserted into an object.

In this embodiment or other embodiments, the first outer sleeving portion 21 can be optionally sleeved on the first side rod portion 12 of the inner rod 10, the first inner sleeving portion 22 can be optionally sleeved on the first end 111 of the inner rod 10, and both the second outer sleeving portion 31 and the second inner sleeving portion 32 can be optionally sleeved on the second side rod portion 13 of the inner rod 10. In this way, the two sleeves to selectively expose or conceal the two side rod portions of the inner rod 10 by sliding on the inner rod 10 to adapt to different objects.

In this embodiment or other embodiments, an outer ring surface 121 of the first side rod portion 12 of the inner rod 10 can be optionally provided with an engaging groove 122 on the end thereof away from the main rod portion 11. The engaging groove 122 is for the first object OB1 to enter thereinto, so that the first end of the multifunctional adapter device 1 can be stably inserted into an object.

In this embodiment or other embodiments, an outer ring surface 131 of the second side rod portion 13 of the inner rod 10 can be optionally provided with a receiving groove 132. The multifunctional adapter device 1 further includes an engaging member 40 and a spring 50. Both the engaging member 40 and the spring 50 are arranged in the receiving groove 132. The two opposite ends of the spring 50 respectively abut against the engaging member 40 and a bottom surface 133 of the receiving groove 132, and the engaging member 40 is used to engage with the third object OB3. In this way, the second end of the multifunctional adapter device 1 can be stably inserted into an object.

In this embodiment or other embodiments, an outer ring surface 113 of the main rod portion 11 can be optionally provided with a first limiting groove 114 and a first limiting groove 115 which are separated from each other in the extension direction T of the multifunctional adapter device 1. An inner surface 221 of the first inner sleeving portion 22 of the first sleeve 20 can be optionally provided with a first annular groove 222. The multifunctional adapter device 1 can optionally further include a first snap ring 61 movably arranged in the first annular groove 222. Therefore, when the first sleeve 20 is in the first inner position, the first snap ring 61 enters the first limiting groove 115; and when the first sleeve 20 is in the first outer position, the first snap ring 61 enters the first limiting groove 114. Moreover, the outer ring surface 131 of the second side rod portion 13 can be optionally provided with a second limiting groove 134. The inner surface 321 of the second inner sleeving portion 32 of the second sleeve 30 can be optionally provided with a second annular groove 322. The multifunctional adapter device 1 can optionally further include a second snap ring 62 movably arranged in the second annular groove 322. Therefore, when the second sleeve 30 is in the second inner position, the second snap ring 60 abuts against the outer ring surface 131 of the second side rod portion 13; and when the second sleeve 30 is in the second outer position, the second snap ring 62 enters the second limiting groove 134. In this way, such a configuration contributes to limiting the sliding stroke length of the two sleeves on the inner rod 10.

In this embodiment or other embodiments, the multifunctional adapter device 1 can optionally further include a snap ring 63. The snap ring 63 is sleeved on the sleeve extension 23 of the first sleeve 20 and clamped between the first outer sleeving portion 21 and the annular protrusion 232 of the sleeve extension 23. In this way, such a configuration contributes to limiting the depth of the first outer sleeving portion 21 entering the fifth object OB5.

In this embodiment or other embodiments, an outer end surface 123 of the first side rod portion 12 of the inner rod 10 can be optionally provided with a groove 124. The multifunctional adapter device 1 can optionally further include a magnetic member M1, which is arranged in the groove 124. This helps the multifunctional adapter device 1 to adsorb objects and prevent them from falling.

In this embodiment or other embodiments, an outer end surface 135 of the second side rod portion 13 of the inner rod 10 can be optionally provided with a groove 136. The multifunctional adapter device 1 can optionally further include a magnetic member M2, which is arranged in the groove 136. This helps the multifunctional adapter device 1 to adsorb objects and prevent them from falling.

In this embodiment or other embodiments, an outer end surface 323 of the second inner sleeving portion 32 of the second sleeve 30 can be optionally provided with one or more grooves 324. The multifunctional adapter device 1 can optionally further include one or more magnetic members M3, which are arranged in the grooves 324. This helps the multifunctional adapter device 1 to adsorb objects and prevent them from falling.

Although the present invention has been disclosed above with the foregoing embodiments, these embodiments are not intended to limit the present invention. Any changes, modifications, and combinations of various implementation forms within the spirit and scope of the present invention all fall within the scope of patent protection of the present invention. Please refer to the attached Claims.

What is claimed is:

1. A multifunctional adapter device, suitable for connecting different objects, and comprising:
an inner rod, including a main rod portion, a first side rod portion connected to a first end of the main rod portion, and a second side rod portion connected to a second end of the main rod portion opposite to the first end of the main rod portion;
a first sleeve, slidably sleeved on the inner rod, and including a first inner position and a first outer position relative to the inner rod; and
a second sleeve, slidably sleeved on the inner rod, and including a second inner position and a second outer position relative to the inner rod;
wherein, when the first sleeve is in the first inner position, the first side rod portion of the inner rod protrudes from the first sleeve in an extension direction of the multifunctional adapter device, so as to allow the first side rod portion to be inserted into a first object;
when the first sleeve is in the first outer position, the first side rod portion of the inner rod retracts into the first sleeve, so as to allow a second object to be inserted into the first sleeve;
when the second sleeve is in the second inner position, the second side rod portion of the inner rod protrudes from the second sleeve in the extension direction of the multifunctional adapter device, so as to allow the second side rod portion to be inserted into a third object; and
when the second sleeve is in the second outer position, the second side rod portion of the inner rod retracts into the second sleeve, so as to allow a fourth object to be inserted into the second sleeve.

2. The multifunctional adapter device as claimed in claim 1, wherein a shape of a projection of the first side rod portion in the extension direction of the multifunctional adapter device is different from that of the second side rod portion in the extension direction of the multifunctional adapter device.

3. The multifunctional adapter device as claimed in claim 1, wherein an inner diameter of the second sleeve is different from that of the first sleeve.

4. The multifunctional adapter device as claimed in claim 1, wherein the first sleeve includes a first outer sleeving portion and a first inner sleeving portion connected to the first outer sleeving portion, and the first outer sleeving portion is for the second object to be inserted thereinto;
the second sleeve includes a second outer sleeving portion and a second inner sleeving portion connected to the second outer sleeving portion, and the second outer sleeving portion is for the fourth object to be inserted thereinto; and
an inner diameter of the first outer sleeving portion is different from that of the second outer sleeving portion.

5. The multifunctional adapter device as claimed in claim 1, wherein the first sleeve includes a first outer sleeving portion and a first inner sleeving portion connected to the first outer sleeving portion, and the first outer sleeving portion is for the second object to be inserted thereinto;
the second sleeve includes a second outer sleeving portion and a second inner sleeving portion connected to the second outer sleeving portion, and the second outer sleeving portion is for the fourth object to be inserted thereinto;
an outer diameter of the first outer sleeving portion of the first sleeve, a contour shape of a projection of the first outer sleeving portion in the extension direction of the multifunctional adapter device, or both are different from that of the first inner sleeving portion, and when the first sleeve is in the first outer position, the first outer sleeving portion is capable of being inserted into a fifth object; and
an outer diameter of the second outer sleeving portion of the second sleeve, a contour shape of a projection of the second outer sleeving portion in the extension direction of the multifunctional adapter device, or both are different from that of the second inner sleeving portion, and when the second sleeve is in the second outer position, the second outer sleeving portion is capable of being inserted into a sixth object.

6. The multifunctional adapter device as claimed in claim 1, wherein the first sleeve includes a first outer sleeving portion and a first inner sleeving portion connected to the first outer sleeving portion, and the first outer sleeving portion is for the second object to be inserted thereinto;
the second sleeve includes a second outer sleeving portion and a second inner sleeving portion connected to the second outer sleeving portion, and the second outer sleeving portion is for the fourth object to be inserted thereinto;
an outer diameter of the first outer sleeving portion of the first sleeve, a contour shape of a projection of the first outer sleeving portion in the extension direction of the multifunctional adapter device, or both are different from that of the second outer sleeving portion of the second sleeve, the first outer sleeving portion is configured to be inserted into a fifth object, and the second outer sleeving portion is configured to be inserted into a sixth object.

7. The multifunctional adapter device as claimed in claim 1, wherein the first sleeve includes a first outer sleeving portion and a first inner sleeving portion connected to the first outer sleeving portion, and the first outer sleeving portion is for the second object to be inserted thereinto; and
the first sleeve further includes a sleeve extension connected to an end of the first outer sleeving portion away from the first inner sleeving portion, an outer ring surface of the sleeve extension is provided with an annular protrusion, and a contour shape of a projection of the annular protrusion in the extension direction of the multifunctional adapter device is different from that of the first outer sleeving portion.

8. The multifunctional adapter device as claimed in claim 7, further comprising a snap ring, which is sleeved on the sleeve extension of the first sleeve and located between the first outer sleeving portion and the annular protrusion of the sleeve extension.

9. The multifunctional adapter device as claimed in claim 1, wherein the first sleeve includes a first outer sleeving portion and a first inner sleeving portion connected to the first outer sleeving portion, and the first outer sleeving portion is for the second object to be inserted thereinto;
the second sleeve includes a second outer sleeving portion and a second inner sleeving portion connected to the second outer sleeving portion, and the second outer sleeving portion is for the fourth object to be inserted thereinto; and
the first outer sleeving portion is sleeved on the first side rod portion of the inner rod, the first inner sleeving portion is sleeved on the first end of the main rod portion of the inner rod, and both the second outer sleeving portion and the second inner sleeving portion are sleeved on the second side rod portion of the inner rod.

10. The multifunctional adapter device as claimed in claim 1, wherein a engaging groove is provided on one end of the first side rod portion away from the main rod portion, and the engaging groove is for the first object to enter thereinto.

11. The multifunctional adapter device as claimed in claim 1, wherein a receiving groove is provided on one end of the second side rod portion away from the main rod portion, the multifunctional adapter device further comprises an engaging member and a spring, the engaging member and the spring are arranged in the receiving groove, two opposite ends of the spring respectively abut against the engaging member and a bottom surface of the receiving groove, and the engaging member is used to engage with the third object.

12. The multifunctional adapter device as claimed in claim 1, wherein an outer ring surface of the main rod portion is provided with two first limiting grooves which are separated from each other in the extension direction of the multifunctional adapter device, and an inner surface of the first sleeve is provided with a first annular groove;
an outer ring surface of the second side rod portion is provided with a second limiting groove, and an inner surface of the second sleeve is provided with a second annular groove;
the multifunctional adapter device further comprises a first snap ring movably arranged in the first annular groove and a second snap ring movably arranged in the second annular groove;
when the first sleeve is in the first inner position, the first snap ring enters one of the first limiting grooves;
when the first sleeve is in the first outer position, the first snap ring enters the other one of the first limiting grooves;
when the second sleeve is in the second inner position, the second snap ring abuts against the outer ring surface of the second side rod portion; and
when the second sleeve is in the second outer position, the second snap ring enters the second limiting groove.

13. The multifunctional adapter device as claimed in claim 1, wherein at least one of outer end surfaces of the first side rod portion and the second side rod portion is provided with a magnetic member.

14. The multifunctional adapter device as claimed in claim 1, wherein the second sleeve is provided with a magnetic member.
